(19) United States
(12) Patent Application Publication
(10) Pub. No.: US 2013/0252015 A1
(43) Pub. Date: Sep. 26, 2013

(54) MOTORCYCLE ACCESSORY CREATED WITH A FONT

(71) Applicant: Fredrick S. Farrington, Sanford, FL (US)

(72) Inventor: Fredrick S. Farrington, Sanford, FL (US)

(21) Appl. No.: 13/848,000

(22) Filed: Mar. 20, 2013

Related U.S. Application Data
(60) Provisional application No. 61/649,302, filed on May 20, 2012.
(60) Provisional application No. 61/613,445, filed on Mar. 20, 2012.

(51) Int. Cl. B62M 25/06; B62K 11/00; H01Q 1/32

(52) U.S. Cl. CPC B62M 25/06; H01Q 1/32; B62K 11/00
USPC 428/600; 428/544; 29/527.4; 29/460

(57) ABSTRACT

A fully customized motorcycle part or accessory can include a font-based designed cut therein. The font-based customized design may be cut in metal that forms the part or accessory, such as a shift linkage, antenna, floorboards, and the like, or may be cut in a separate accessory or a separate part of the motorcycle, such as in the bag of a Harley-Davidson® Bagger motorcycle.

### CROSS-REFERENCE TO RELATED APPLICATION

This application claims the benefit of priority of U.S. provisional application No. 61/613445, filed Mar. 20, 2012, and U.S. provisional application No. 61/649,302, filed May 20, 2012, the contents of which are herein incorporated by reference.

### BACKGROUND OF THE INVENTION

The present invention relates to motorcycle accessories and, more particularly, to a motorcycle accessory created with a font made by a water jet or laser cutting system.

In the world of motorcycle accessories and parts, there is a lack of customizing ability. Most items on the market for the consumer to choose from are mass produced products with no originality for each individual customer.

For example, if a user desires a different shift linkage for their motorcycle, they may look online and find various vendors that mass-produce and sell a particular design. While the design may be desirable, it is not unique, as anyone else may be able to order the same replacement part and have the same design on their motorcycle.

As can be seen, there is a need for an improved motorcycle accessory that may be customized to the individual's design choice.

### SUMMARY OF THE INVENTION

In one aspect of the present invention, a motorcycle component comprises a font-based design cut into a stock material and adapted to be used as the motorcycle component.

In another aspect of the present invention, a method for customizing a component of a motorcycle comprises cutting a stock material into a font-based design chosen by a user; flattening the stock material to a desired thickness; and finishing the cut stock material with a desired finish.

These and other features, aspects and advantages of the present invention will become better understood with reference to the following drawings, description and claims.

### BRIEF DESCRIPTION OF THE DRAWINGS

FIG. 1 is a side view of a motorcycle having a font-based shift linkage according to an exemplary embodiment of the present invention;

FIG. 2 is a front view of the font-based shift linkage of FIG. 1;

FIG. 3 is a perspective view of the font-based shift linkage of FIG. 1;

FIG. 4 is a perspective view of a font-based antenna according to an exemplary embodiment of the present invention;

FIG. 5 is a detailed perspective view of a motorcycle with a font-based antenna;

FIG. 6 is a flow chart describing a method for making a font-based motorcycle accessory according to an exemplary embodiment of the present invention;

FIG. 7 is a detailed perspective view showing an end attachment piece disposed on a font-based motorcycle accessory; and

FIG. 8 is an exploded perspective view of the font-based accessory of FIG. 7.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a fully customized motorcycle part or accessory where the part or accessory can include a font-based designed cut therein. The font-based customized design may be cut in metal that forms the part or accessory, such as a shift linkage, antenna, floorboards, and the like, or may be cut in a separate accessory or a separate part of the motorcycle, such as in the bag of a Harley-Davidson® Bagger motorcycle.

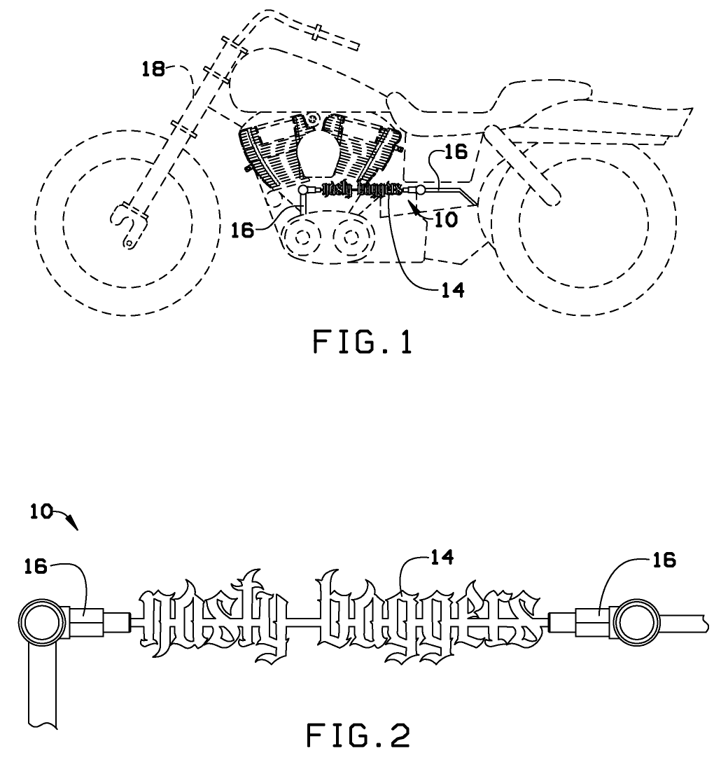

Referring to FIGS. 1 through 3, in some embodiments, a shift linkage 10 may be formed in a custom font-based design 14 by cutting metal, such as aluminum or steel, for example, into a certain font. Rounded connection ends 16 may be added to complete the shift linkage 10. The customized shift linkage 10 may then be chrome plated or painted as desired. In some embodiments, the customized shift linkage 10 may be cut from a single piece of flat stock metal. Then, the font-based designed may be planed to a desired thickness. In some embodiments, the font-based design 14 may be planed to the desired thickness while the ends are not thinned, while in other embodiments, the ends may be thinned along with the font-based design 14. The ends can then be rounded to make a single, integrated shift linkage 10 having the customized font-based designed cut therein.

Different finishes may be applied to the customized shift linkage 10. For example, chrome, metallic paint, glossy paint, flat paint, powder coating, or the like, may be used to finish the product.

The cutting to make the customized shift linkage 10 may be achieved by methods known in the art, such as through a water jet, a laser cutting system, a computer numerical control (CNC) cutting machine, metal stamping, hand-guided metal cutting tools, and the like. Depending on the material, its thickness and the like, the various methods described above, as well as other methods, may be used to cut the item.

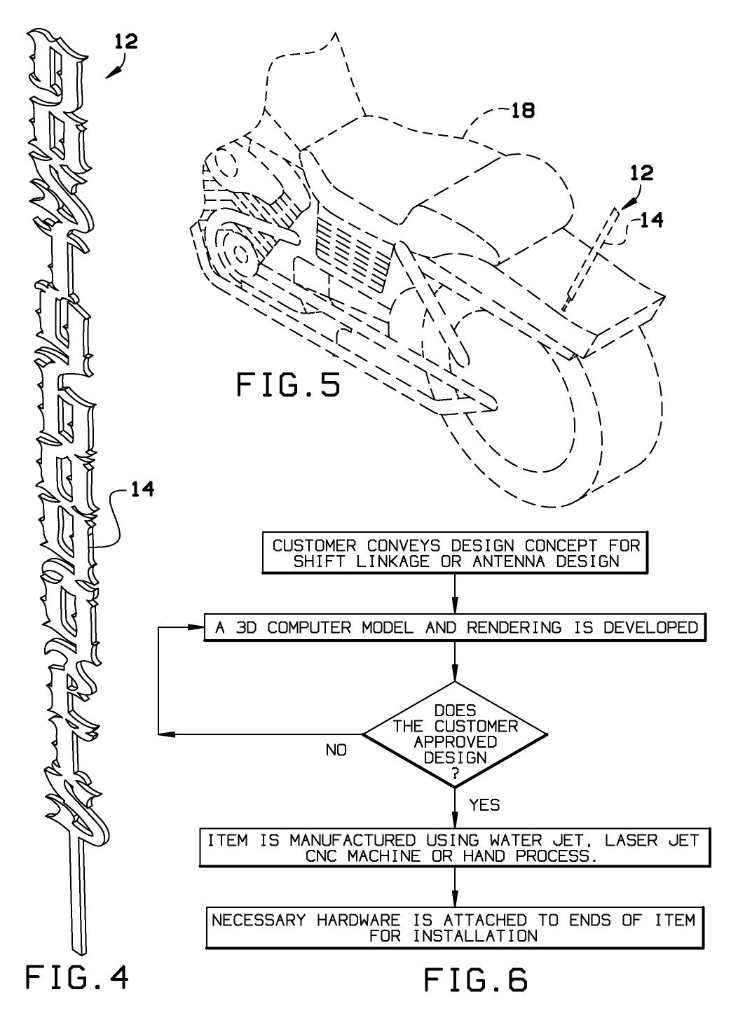

Referring now to FIGS. 4 and 5, the customized part could include an antenna 12 having the font-based design 14 formed therein. The font-based design of the antenna 12 can be the same or different from other font-based designs on a motorcycle 18, such as the shift linkage 10. The antenna of FIGS. 4 and 5 may still achieve the desired results as an antenna while adding a customized style to the motorcycle. The antenna may be designed with a base adapted to mount onto a conventional motorcycle antenna mount.

Referring to FIG. 6, with the method and system of the present invention, a user may simply design what they would like their part to look like. A 3-D computer model and rendering of the design can be developed and a machine shop, or some other cutting facility, can then create the design to then be sent to a chromer/plater for finishing. The necessary hardware can be attached to ends of the item for installation. The end product is a customized part that would not be available in any store or catalog.

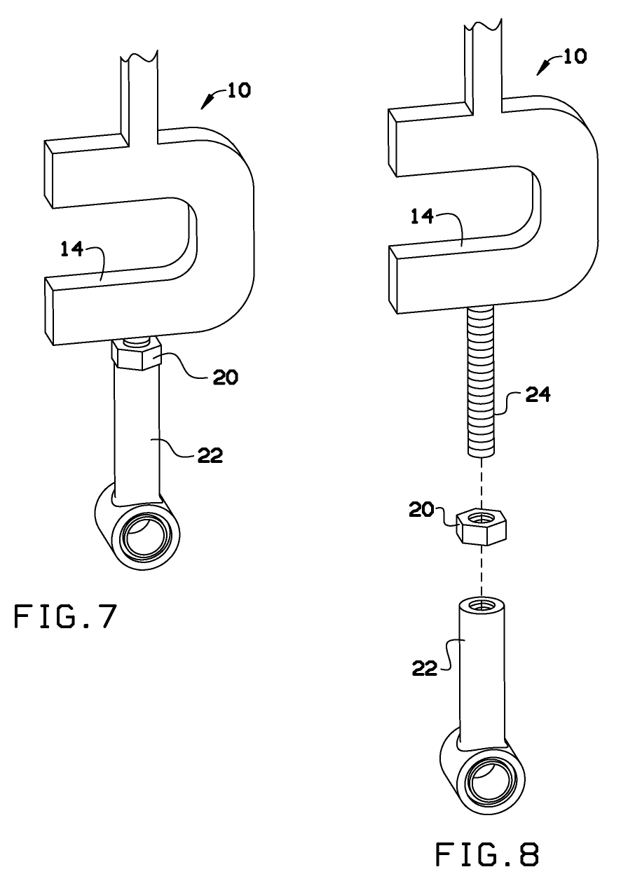

Referring to FIGS. 7 and 8, various end designs can be developed. For example, as discussed above, the ends 24 can be planed the same thickness as the font-based design 14 or may be kept full thickness. In either case, a nut 20 and an end fitting 22 can attach to the ends of the part or accessory. In some embodiments, the ends 24 are threaded to provide an adjustable length of the overall part or accessory, as the end fittings 22 can be adjustably positioned along the length of the ends 24.

While the above description discusses creating a customized motorcycle part with a font-based design formed therein, other items may be similarly customized. The item may be a part, accessory or some other component of the motorcycle.

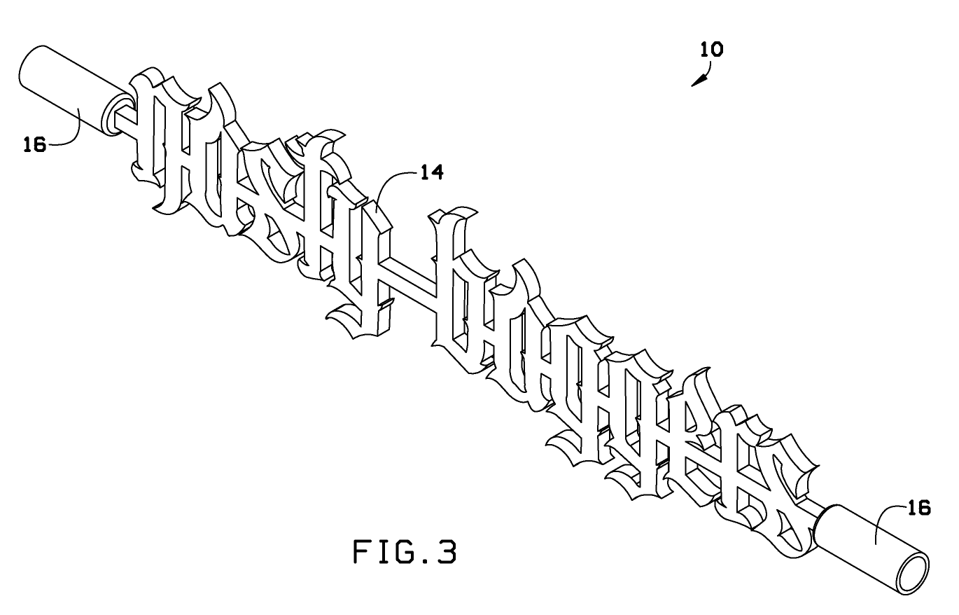

While a particular font is shown in the drawings, the present invention is not meant to be limited to any particular font. The font-based design may also include a graphic, image, or some other design, depending on the needs of the consumer. The font can include letters that spell out a word, brand name, slogan, theme, club name, team name, or some other font-based indication. The font can include, in addition to the letters, a graphic, design, shapes, or the like. The font can include letters that are interconnected along a line so that generally follows a line of the original part. For example, as shown in FIG. 3, the font-based design 14 of a shift linkage 10 includes interconnection along the same line as the original shift linkage so as not to sacrifice strength or function.

It should be understood, of course, that the foregoing relates to exemplary embodiments of the invention and that modifications may be made without departing from the spirit and scope of the invention as set forth in the following claims.

What is claimed is:

1. A motorcycle component comprising:
a font-based design cut into a stock material and adapted to be used as the motorcycle component.

2. The motorcycle component of claim 1, wherein the motorcycle component is a shift linkage.

3. The motorcycle component of claim 1, wherein the motor cycle component is an antenna.

4. The motorcycle component of claim 1, wherein ends of the motorcycle component are planed to a thickness equal to a thickness of the font-based design.

5. The motorcycle component of claim 1, wherein the font-based design is planed to a thickness less than a thickness of ends of the motorcycle component.

6. The motorcycle component of claim 1, wherein at least one end of the motorcycle component is threaded with male threads for connecting the motorcycle component to a motorcycle.

7. The motorcycle component of claim 1, wherein the stock material is a metal material.

8. A method for customizing a component of a motorcycle, comprising:
cutting a stock material into a font-based design chosen by a user;
flattening the stock material to a desired thickness; and
finishing the cut stock material with a desired finish.

9. The method of claim 8, wherein ends of the stock material are flattened in a manner similar to the font-based design.

10. The method of claim 8, further comprising interconnecting the font-based design with stock material to provide suitable strength and function of the customized component.
